(19) United States
(12) Patent Application Publication
(10) Pub. No.: US 2016/0068378 A1
(43) Pub. Date: Mar. 10, 2016

(54) CHAIN HOIST

(71) Applicant: Konecranes Plc, Hyvinkaa (FI)

(72) Inventor: Fabrice COPIN, Vernouillet (FR)

(73) Assignee: Konecranes Plc, Hyvinkaa (FI)

(21) Appl. No.: 14/481,610

(22) Filed: Sep. 9, 2014

(51) Int. Cl. B66D 3/20; B66D 3/26

(52) U.S. Cl. CPC B66D 3/20; B66D 3/26

(57) ABSTRACT

A chain hoist includes a body; a hoist chain passing through the body; through-holes in the body for the hoist chain; and an actuator arrangement for operating the chain hoist, the actuator being used for moving the hoist chain through said through-holes in a lifting or lowering direction of the chain hoist, and on the side of at least one through-hole the portion of the hoist chain moving outside the body is provided with a limiter member whose position in the longitudinal direction of the hoist chain is adjustable, the limiter member being provided with a detectable sensor; and a sensor detection member is provided in the vicinity of said through-hole to detect the detectable sensor at a predetermined distance.

### BACKGROUND OF THE INVENTION

The invention relates to a chain hoist comprising a body; a hoist chain passing through the body; a first through-hole in the body for the hoist chain; a second through-hole in the body for the hoist chain; an actuator arrangement for operating the chain hoist, the actuator being used for moving the hoist chain through said through-holes in a lifting or lowering direction of the chain hoist.

A chain hoist of the invention is used particularly in theatre applications or the like in which an object to be lifted, such as a scenic object, must be lifted or lowered rapidly and precisely to the correct height.

In prior art solutions the correct height must be estimated by the eye and the hoist must be stopped on the basis of this, usually inaccurate, estimate which means that corrective moves have to be made. In connection with this, accidents may happen due to the object to be lifted hitting something and thus damaging both the object and the environment. In the worst case scenario personal injury may occur.

### SUMMARY OF THE INVENTION

An object of the invention is to provide a novel chain hoist so as to enable the above-described problems to be solved. This is achieved by a chain hoist of the invention, characterized in that on the side of at least one through-hole the portion of the hoist chain moving outside the body is provided with a limiter member whose position in the longitudinal direction of the hoist chain is adjustable, the limiter member being provided with a detectable sensor; and a sensor detection member is provided in the vicinity of said through-hole to detect the detectable sensor at a predetermined distance.

The sensor detection member most preferably communicates directly with the actuator arrangement for stopping the chain hoist when the limiter member and the sensor provided therein are at said detection distance from the sensor detection member.

Other preferred embodiments of the invention are disclosed in the dependent claims.

With the chain hoist of the invention all hoists can be made precisely to the right position after the lifting heights have been determined by the limiter member that is preferably slidable on the hoist chain and lockable to a desired position, the sensor in the limiter member and the sensor in the body then co-operating to provide a stop command to the chain hoist actuator. The invention provides such precision that the limiter member may be stopped at a distance of one chain loop from the hoist body. This allows an automated lifting height to be determined with extreme precision.

The solution of the invention is simple by design and affordable to implement, and it is also suitable for retrofitting existing chain hoists. In addition to the uses mentioned at the beginning, also industrial applications of the chain hoist are possible.

### LIST OF FIGURES

The invention is now described in closer detail by means of one preferred embodiment and with reference to the accompanying drawings, in which

FIG. 1 is a cross-sectional view of a chain hoist of the invention; and

FIG. 2 is an explosion view of a limiter member visible in FIG. 1.

### DETAILED DESCRIPTION OF THE INVENTION

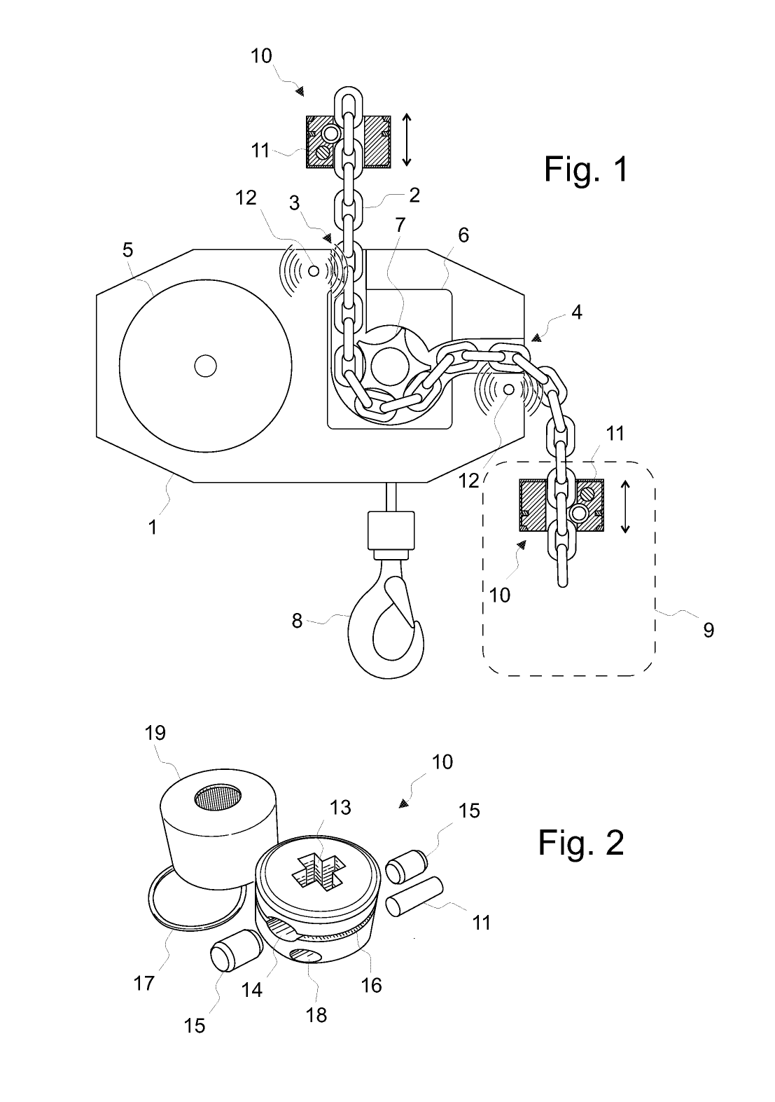

With reference to FIG. 1, a chain hoist of the invention comprises a body 1; a hoist chain 2 passing through the body 1; a first, upper, through-hole 3 in the body 1 for the hoist chain 2; a second, lower, through-hole 4 in the body 1 for the hoist chain 2, and an actuator arrangement 5, 6, 7 (an electric motor 5, a gear 6 and a chain wheel 7) for operating the chain hoist, the arrangement being used for moving the hoist chain 2 through the through-holes 3 and 4 in a lifting or lowering direction of the chain hoist. In this application the through-hole 3 is on an upper surface of the body 1 and the through-hole 4 on a side surface of the body 1. In this application a lifting hook 8 needed in the lifting is attached to an underside of the body 1. The top end of the hoist chain 2 is fastened to a support structure (not shown) provided up in the lifting space by e.g. a second lifting hook (not shown) fastened to the top end of the hoist chain 2. During lifting, the body 1 and the lifting hook 8 move along the hoist chain 2, excess hoist chain 2 being collected into and released from a chain bag 9 arranged below the through-hole 4. Of course, the chain hoist may also be used in a “reverse mode”, i.e. by fastening it to said support structure of the lifting space by the lifting hook 8, the body 1 of the chain hoist being thus stationary and the hoist chain 2 being “reeled” into or out of the body 1 with the chain bag 9 being used also in this case for collecting excess hoist chain 2.

An essential aspect of the chain hoist of the invention is that on the side of at least one through-hole 3, 4 the portion of the hoist chain 2 moving outside the body 1 is provided with a limiter member 10 whose position in the longitudinal direction of the hoist chain 2 is adjustable, the limiter member being provided with a detectable sensor 11; and that a sensor detection member 12 is provided in the vicinity of the through-hole 3, 4 to detect the detectable sensor 11 at a predetermined distance. In this example the limiter member 10 and the detectable sensor 11 are arranged on each part of the hoist chain 2 moving outside the through-holes 3, 4 and the sensor detection member 12 is arranged inside the body 1 at the immediate vicinity of the through-holes 3, 4.

The detectable sensor 11 may be e.g. a magnet and the sensor detection member 12 may be a magnet detector. Also other commonly known detection pairs recognizing one another are possible.

The sensor detection member 12 is configured to communicate directly with the actuator arrangement 6, 7, 8 for stopping the chain hoist when the limiter member 10 and the sensor 11 provided therein are at said detection distance from the sensor detection member 12. This detection distance may be as short as the distance corresponding to a length of one chain loop.

For the limiter member 10 to be easily slidable on the hoist chain 2 and lockable to a desired point there, the limiter member 10 is provided with locking members that press against the hoist chain 2 in a resilient manner.

The limiter member 10 is preferably a cylinder with an axial through-hole 13 for the hoist chain 2, a transverse hole 14 running through the cylinder 10 and intersecting the through-hole 13, locking pins 15 placed in the transverse hole 14 and pressing against the hoist chain 2 on both sides thereof; a peripheral groove 16 running on the outer surface of the cylinder 10 at the transverse hole 14; a resilient locking ring 17 placed into the peripheral groove 16 to keep the locking pins 15 in place in a resilient manner; and a space 18 (drilling) for the sensor 11. In addition, around this assembly there is a resilient rubber cover 19 which also ensures that the above components stay in place.

The above description of the invention is only intended to illustrate the basic idea of the invention. A person skilled in the art may thus vary its details within the scope of the attached claims.

1. A chain hoist, comprising:
a body;
a hoist chain passing through the body;
a first through-hole in the body for the hoist chain;
a second through-hole in the body for the hoist chain;
an actuator arrangement for operating the chain hoist, the actuator being used for moving the hoist chain through said through-holes in a lifting or lowering direction of the chain hoist,
wherein
on the side of at least one through-hole the portion of the hoist chain moving outside the body is provided with a limiter member whose position in the longitudinal direction of the hoist chain is adjustable, the limiter member being provided with a detectable sensor; and
a sensor detection member is provided in the vicinity of said through-hole to detect the detectable sensor at a predetermined distance.

2. The chain hoist as claimed in claim 1, wherein the sensor detection member communicates directly with the actuator arrangement for stopping the chain hoist when the limiter member and the sensor provided therein are at said detection distance from the sensor detection member.

3. The chain hoist as claimed in claim 1, wherein the sensor detection member is placed inside the body, at the immediate vicinity of a through-hole.

4. The chain hoist as claimed in claim 1, wherein the detectable sensor is a magnet and the sensor detection member is a magnet detector.

5. The chain hoist as claimed in claim 1, wherein the limiter member has locking members that press resiliently against the hoist chain.

6. The chain hoist as claimed in claim 1, wherein the limiter member is a cylinder with:
an axial through-hole for the hoist chain;
a transverse hole running through the cylinder and intersecting the through-hole;
locking pins placed into the transverse hole and pressing against the hoist chain on both sides thereof;
a peripheral groove running on the outer surface of the cylinder at the transverse hole;
a resilient locking ring placed into the peripheral groove to keep the locking pins in place in a resilient manner; and
a space for the detectable sensor.

7. The chain hoist as claimed in claim 2, wherein the sensor detection member is placed inside the body, at the immediate vicinity of a through-hole.

8. The chain hoist as claimed in claim 2, wherein the detectable sensor is a magnet and the sensor detection member is a magnet detector.

9. The chain hoist as claimed in claim 3, wherein the detectable sensor is a magnet and the sensor detection member is a magnet detector.

10. The chain hoist as claimed in claim 2, wherein the limiter member has locking members that press resiliently against the hoist chain.

11. The chain hoist as claimed in claim 3, wherein the limiter member has locking members that press resiliently against the hoist chain.

12. The chain hoist as claimed in claim 4, wherein the limiter member has locking members that press resiliently against the hoist chain.

13. The chain hoist as claimed in claim 2, wherein the limiter member is a cylinder with:
an axial through-hole for the hoist chain;
a transverse hole running through the cylinder and intersecting the through-hole;
locking pins placed into the transverse hole and pressing against the hoist chain on both sides thereof;
a peripheral groove running on the outer surface of the cylinder at the transverse hole;
a resilient locking ring placed into the peripheral groove to keep the locking pins in place in a resilient manner; and
a space for the detectable sensor.

14. The chain hoist as claimed in claim 3, wherein the limiter member is a cylinder with:
an axial through-hole for the hoist chain;
a transverse hole running through the cylinder and intersecting the through-hole;
locking pins placed into the transverse hole and pressing against the hoist chain on both sides thereof;
a peripheral groove running on the outer surface of the cylinder at the transverse hole;
a resilient locking ring placed into the peripheral groove to keep the locking pins in place in a resilient manner; and
a space for the detectable sensor.

15. The chain hoist as claimed in claim 4, wherein the limiter member is a cylinder with:
an axial through-hole for the hoist chain;
a transverse hole running through the cylinder and intersecting the through-hole;
locking pins placed into the transverse hole and pressing against the hoist chain on both sides thereof;
a peripheral groove running on the outer surface of the cylinder at the transverse hole;
a resilient locking ring placed into the peripheral groove to keep the locking pins in place in a resilient manner; and
a space for the detectable sensor.

16. The chain hoist as claimed in claim 5, wherein the limiter member is a cylinder with:
an axial through-hole for the hoist chain;
a transverse hole running through the cylinder and intersecting the through-hole;
locking pins placed into the transverse hole and pressing against the hoist chain on both sides thereof;
a peripheral groove running on the outer surface of the cylinder at the transverse hole;
a resilient locking ring placed into the peripheral groove to keep the locking pins in place in a resilient manner; and
a space for the detectable sensor.
